(19) United States
(12) Patent Application Publication
(10) Pub. No.: US 2024/0013464 A1
(43) Pub. Date: Jan. 11, 2024

(54) MULTIMODAL DISENTANGLEMENT FOR GENERATING VIRTUAL HUMAN AVATARS

(71) Applicant: SAMSUNG ELECTRONICS CO., LTD., Gyeonggi-Do (KR)

(72) Inventors: Siddarth Ravichandran, Santa Clara, CA (US); Dimitar Petkov Dinev, Sunnyvale, CA (US); Ondrej Texler, San Jose, CA (US); Ankur Gupta, San Jose, CA (US); Janvi Chetan Palan, Santa Clara, CA (US); Hyun Jae Kang, Mountain View, CA (US); Anthony Sylvain Jean-Yves Liot, San Jose, CA (US); Sajid Sadi, San Jose, CA (US)

(21) Appl. No.: 18/296,202

(22) Filed: Apr. 5, 2023

Related U.S. Application Data
(60) Provisional application No. 63/359,950, filed on Jul. 11, 2022.

(51) Int. Cl. G06T 13/40; G06T 13/20; G06T 5/50; G06T 7/13; G06T 7/73; G06V 10/74

(52) U.S. Cl. CPC G06T 13/40; G06T 13/205; G06T 5/50; G06T 7/13; G06T 7/73; G06V 10/761; G06T 2207/20081; G06T 2207/20221; G06T 2207/30201

(57) ABSTRACT

Multimodal disentanglement can include generating a set of silhouette images corresponding to a human face, the generating undoing a correlation between an upper portion and a lower portion of the human face depicted by each silhouette image. A unimodal machine learning model can be trained with the set of silhouette images. As trained, the unimodal machine learning model can generate synthetic images of the human face. The synthetic images generated by the unimodal machine learning model once trained can be used to train a multimodal rendering network. The multimodal rendering network can be trained to generate a voice-animated digital human. Training the multimodal rendering network can be based on minimizing differences between the synthetic images and images generated by the multimodal rendering network.

### CROSS-REFERENCE TO RELATED APPLICATIONS

This application claims the benefit of U.S. Application No. 63/359,950 filed on Jul. 11, 2022, which is incorporated herein by reference in its entirety.

### TECHNICAL FIELD

This disclosure relates to machine learning and image processing, and more particularly, to generating virtual humans and other avatars using machine learning.

### BACKGROUND

The ability to generate high quality images of characters, whether digital humans, avatars, or other anthropomorphized objects, is increasingly important. Among the reasons for the increasing importance are the growing popularity of the Metaverse, the adoption of virtual experiences across different segments of society, and recent advances in hardware and other technologies (e.g., neural networks) that facilitate rapid virtualization. For example, the goal for rendering a digital human is to closely, if not perfectly, resemble a real human. In achieving this goal, the quality of both the textures used and the resolution of the resulting images play important roles. It is preferable that the digital human image be rendered with correct textures such that hair looks like it is composed of individual hair strands; that skin appears to have pores; that clothing look like it is made of fabric, etc. Even for other use cases such as the generation of an avatar—whether a human-like character, a humanoid character, or other anthropomorphized object—the accuracy and realism of the images rendered is important.

In many cases digital humans, avatars, and the like are presented on large screens. A digital human may be presented, for example, at an airport or hotel kiosk on a screen with a life-sized rendering (e.g., of average height and size corresponding to a real human). A life-sized rendering tends to highlight any visual irregularities and thus the generation of high-quality images of digital humans, avatars, and other anthropomorphized objects remains challenging. Accurate generation of certain features such as movements of the mouth and/or lips of the images is important since the perception of such regions by actual humans is very sensitive to any perceivable visual artifacts, such as the misalignment of a digital human's mouth and lip movements and the digital human's speech.

### SUMMARY

In one or more embodiments, a computer-implemented method includes generating a set of silhouette images corresponding to a human face, the generating undoing a correlation between an upper portion and a lower portion of the human face depicted by each silhouette image. The method includes training a unimodal machine learning model to generate synthetic images of the human face, the unimodal model trained with the set of silhouette images. The method includes outputting, by the unimodal machine learning model, synthetic images for training a multimodal rendering network to generate a voice-animated digital human. Training the multimodal rendering network is based on minimizing differences between the synthetic images and images generated by the multimodal rendering network.

In one aspect, generating a silhouette image can include randomly pairing a first silhouette image with a second silhouette image, the first silhouette image and the second silhouette image depicting an upper half and a lower half of the human face, respectively. The silhouette image is generated by merging the first silhouette image and the second silhouette image.

In another aspect, merging the first silhouette image and the second silhouette image can include extracting associated sets of keypoints from each of the first silhouette image and the second silhouette image, frontalizing the sets of keypoints of each of the first silhouette image and the second silhouette image, generating a frontalized silhouette by adding frontalized sets of keypoints of the first silhouette image and the second silhouette image, and de-frontalizing the frontalized silhouette, thereby generating the silhouette image.

In another aspect, frontalizing the sets of keypoints can include multiplying the sets of keypoints of the first silhouette image and the second silhouette image by an inverse of a head pose matrix of the first image and an inverse of a head pose matrix of the second silhouette image, respectively. De-frontalizing the frontalized silhouette can include multiplying the frontalized silhouette by either the head pose matrix of the first image, or the head pose matrix of the second image.

In another aspect, generating each synthetic image can include performing an image-to-image transformation of a corresponding merged silhouette image.

In one or more embodiments, a system includes one or more processors configured to initiate operations. The operations include generating a set of silhouette images corresponding to a human face, the generating undoing a correlation between an upper portion and a lower portion of the human face depicted by each silhouette image. The operations include training a unimodal machine learning model to generate synthetic images of the human face, the unimodal model trained with the set of silhouette images. The operations include outputting, by the unimodal machine learning model, synthetic images for training a multimodal rendering network to generate a voice-animated digital human. Training the multimodal rendering network is based on minimizing differences between the synthetic images and images generated by the multimodal rendering network.

In one aspect, generating a silhouette image can include randomly pairing a first silhouette image with a second silhouette image, the first silhouette image and the second silhouette image depicting an upper half and a lower half of the human face, respectively. The silhouette image is generated by merging the first silhouette image and the second silhouette image.

In another aspect, merging the first silhouette image and the second silhouette image can include extracting associated sets of keypoints from each of the first silhouette image and the second silhouette image, frontalizing the sets of keypoints of each of the first silhouette image and the second silhouette image, generating a frontalized silhouette by adding frontalized sets of keypoints of first and second silhouette images, and de-frontalizing the frontalized silhouette, thereby generating the silhouette image.

In another aspect, frontalizing the sets of keypoints can include multiplying the sets of keypoints of the first silhouette image and the second silhouette image by an inverse of a head pose matrix of the first image and an inverse of a head pose matrix of the second silhouette image, respectively. De-frontalizing the frontalized silhouette can include multiplying the frontalized silhouette by either the head pose matrix of the first image, or the head pose matrix of the second image.

In another aspect, generating each synthetic image can include performing an image-to-image transformation of a corresponding merged silhouette image.

In one or more embodiments, a computer program product includes one or more computer readable storage media having program code stored thereon. The program code is executable by one or more processors to perform operations. The operations include generating a set of silhouette images corresponding to a human face, the generating undoing a correlation between an upper portion and a lower portion of the human face depicted by each silhouette image. The operations include training a unimodal machine learning model to generate synthetic images of the human face, the unimodal model trained with the set of silhouette images. The operations include outputting, by the unimodal machine learning model, synthetic images for training a multimodal rendering network to generate a voice-animated digital human. Training the multimodal rendering network is based on minimizing differences between the synthetic images and images generated by the multimodal rendering network.

In one aspect, generating a silhouette image can include randomly pairing a first silhouette image with a second silhouette image, the first silhouette image and the second silhouette image depicting an upper half and a lower half of the human face, respectively. The silhouette image is generated by merging the first silhouette image and the second silhouette image.

In another aspect, merging the first silhouette image and the second silhouette image can include extracting associated sets of keypoints from each of the first silhouette image and the second silhouette image, frontalizing the sets of keypoints of each of the first silhouette image and the second silhouette image, generating a frontalized silhouette by adding frontalized sets of keypoints of first and second silhouette images, and de-frontalizing the frontalized silhouette, thereby generating the silhouette image.

In another aspect, frontalizing the sets of keypoints can include multiplying the sets of keypoints of the first silhouette image and the second silhouette image by an inverse of a head pose matrix of the first image and an inverse of a head pose matrix of the second silhouette image, respectively. De-frontalizing the frontalized silhouette can include multiplying the frontalized silhouette by either the head pose matrix of the first image, or the head pose matrix of the second image.

In another aspect, generating each synthetic image can include performing an image-to-image transformation of a corresponding merged silhouette image.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings.

FIG. 1 illustrates an example of an architecture that is executable by a data processing system to perform image generation.

FIG. 2 illustrates certain operative aspects of the architecture of FIG. 1.

FIG. 3 illustrates certain operative aspects of the architecture of FIG. 1.

FIG. 4 illustrates certain operative aspects of the architecture of FIG. 1.

FIG. 5 illustrates an example method that may be performed by a system executing the architecture of FIG. 1.

FIG. 6 illustrates an example multimodal rendering network trained using output of the architecture of FIG. 1.

FIG. 7 illustrates an example implementation of a data processing system capable of executing the architecture described within this disclosure.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to machine learning and image processing, and more particularly, to generating virtual human and other avatars using machine learning. The process of manually creating digital humans is extremely labor-intensive and may not produce realistic representations. To overcome the challenges, neural networks and deep learning techniques are increasingly relied on for generating virtual human avatars. Creating virtual human avatars using machine learning (e.g., neural networks, deep learning), however, presents other unique challenges. Among the challenges are training a machine learning model on multimodal data. Multimodal data imposes multiple model constraints corresponding to speech, body pose, body shape, and other features of multimodal data. Speech can be represented as a vector (corresponding to an audio wave), body pose can be represented as a rotation matrix, and body shape can be represented as 2D image contours. Training deep neural networks on multimodal data is especially challenging because the multimodal data tends to be correlated. Thus, the model tends to overfit with respect to the modality that the model most easily learns and thus most influences the model's training. The overfitting leads to a machine learning model that has very poor performance with respect to processing multimodal test data. Conventional techniques for mitigating overfitting, such as reducing the number of parameters, regularization, and the like, fail if the overfitting is caused by multiple modalities of the training data.

In accordance with the inventive arrangements disclosed herein, methods, systems, and computer program products are described that are capable of disentangling multiple modalities and undoing correlations between the modalities. An aspect of the inventive arrangements is the generation of synthetic data that can be used in training a multimodal rendering network. “Synthetic” means generated for the specific purpose of disentangling different modalities and undoing correlations between the modalities. In one aspect “synthetic” means machine generated for the aforementioned purpose. The term applies herein with respect to both images and data. By disentangling image and audio modalities, the synthetic data can be used to train the multimodal rendering network to render voice-animated digital humans in which head motions are accurately aligned with the mouth and lip movements of the digital humans. In one aspect, “voice-animated digital human” means a plurality of human-like images that are rendered sequentially and in conjunction with an audio rendering of human speech.

The inventive arrangements can be applied to various tasks where modality entanglement is an issue or where generalization of machine learning is needed.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

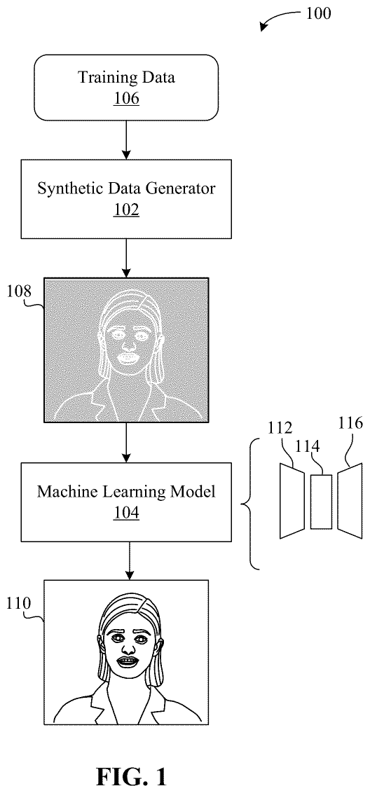

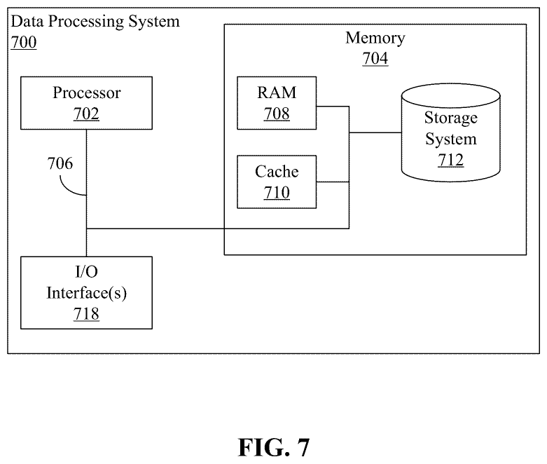

FIG. 1 illustrates an example computer-implemented architecture 100 capable of generating synthetic images. The synthetic images may be used to train a multimodal rendering network to generate voice-animated digital humans. Architecture 100 may be implemented as a software framework that is executable by a data processing system. An example of a data processing system that is suitable for executing architecture 100 and/or training a machine learning model included in architecture 100 is described herein in connection with FIG. 7

Architecture 100 illustratively includes synthetic data generator 102 and machine learning model 104. Synthetic data generator 102 and machine learning model 104 are illustratively arranged in series as a pipeline.

Operatively, synthetic data generator 102 generates synthetic data from the input of training data 106. Training data 106 is multimodal data whose modalities include image and audio modalities. The operations of synthetic data generator 102 disentangle the modalities of training data 106. The disentanglement undoes correlations between the image and audio modalities of training data 106. Undoing the correlations, synthetic data generator 102 outputs silhouette images 108 that correspond to a human face. Silhouette images 108 are generated during preprocessing using a filter or processor to extract keypoints and contours from an image of the human face. The keypoints and contours of silhouette image 108 are thus pixelwise aligned features of the human face.

Silhouette images comprise edge contours and keypoints of the human face. Keypoints are individual points corresponding to different parts of a face, such as corners of the lips, corners of the eyes, etc. The keypoints can be used in generating images of the face, including the mouth, and can operate as landmarks that guide image generation.

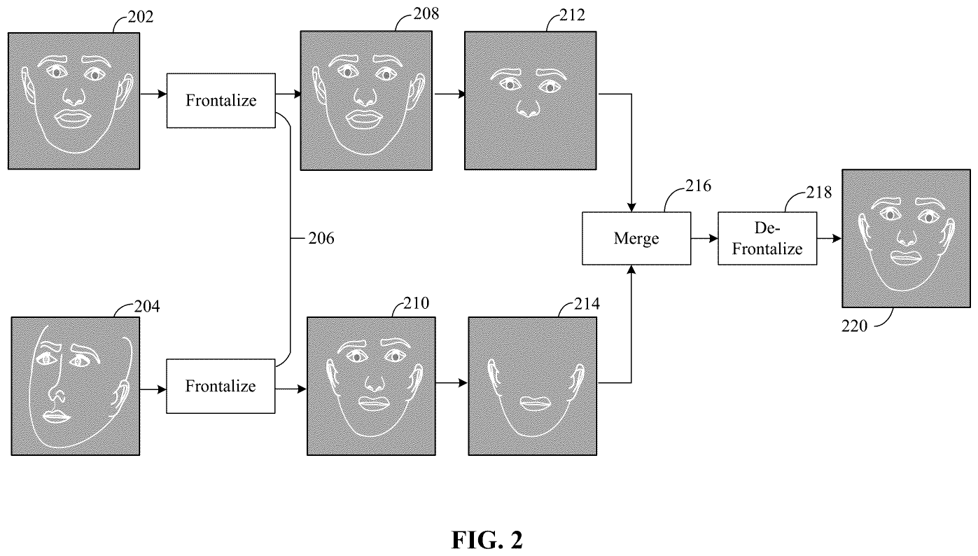

FIG. 2 illustrates example process 200, as performed by synthetic data generator 102, of generating silhouette images 108. Synthetic data generator 102 generates each of silhouette images 108 in a way that eliminates the correlation between the head motion and the mouth motion of an image of a human face. As generated, the upper head portion of each of silhouette images 108 is uncorrelated with the lower head portion, especially the mouth, of each of silhouette images 108. Initially, synthetic data generator 102 randomly selects a pair of image frames, i and j, from training data 106. Illustratively, the randomly paired image frames are i-th frame 202 and j-th frame 204. Synthetic data generator 102 performs operation 206 on both frames. Operation 206 frontalizes each of i-th frame 202 and j-th frame 204, generating frontalized frame 208 and frontalized frame 210, respectively. Operation 206 is performed by multiplying keypoints Kᵢ of i-th frame 202 and keypoints Kⱼ of j-th frame 204 by the inverses of matrices Pᵢ and Pⱼ, respectively, where Pᵢ is the head pose matrix of i-th frame 202 and Pⱼ is the head pose matrix of j-th frame 204.

Multiplying each of keypoints Kᵢ and Kⱼ by the inverse of their respective head pose matrices, yields keypoints Kᵢ′ and Kⱼ′. Frame 208 is passed through a filter or processor that passes only the upper portion of the frame, generating frame 212. Frame 210 is passed through a filter or processor that passes only the lower portion of the frame, generating frame 214. Thus, frame 212 is the upper portion of frame 208, and frame 214 is the lower portion of frame 210. Having frontalized the frames, the keypoints K_{i upper}′ of frame 212 (upper portion) and the keypoints of K_{j lower}′ of frame 214 (lower portion) are in the same 2D space. Being in the same 2D space, the keypoints can be merged by matrix addition,

K_{merged}′=K_{i upper}′+K_{j lower}′,

thus performing operation 216. Operation 216 merges the upper and lower keypoints into a single, merged frame. Operation 218 is performed to de-frontalize the merged frame and generate merged keypoints K_{merged}. De-frontalizing the frontalized merged frame is performed by multiplying the frontalized keypoints K_{merged}′ by either the head pose matrix Pᵢ, or the head pose matrix Pⱼ. For example, if operation 218 is performed by multiplying keypoints K_{merged}′ by the head pose matrix Pᵢ, then

K_{merged}=PᵢK_{merged}′.

Both sets of keypoints—keypoints Kᵢ of i-th frame 202 and keypoints Kᵢ of j-th frame 204—can be used to generate synthetic data and thus the matrix multiplication yields a new image that disentangles the mouth from the pose of the image. Accordingly, de-frontalizing the frontalized merged frame can be performed with matrix multiplication of keypoints K_{merged}′ by either the head pose matrix Pᵢ, or the head pose matrix P_{j′}.

Synthetic data generator 102 generates frame 220, corresponding to silhouette image Xᵢⱼ, from the keypoints K_{merged}. Each of the other of silhouette images 108 can be generated in the same way as silhouette image Xᵢⱼ by repeating process 200 for the rest of training data 106.

Silhouette images 108 are fed into machine learning model 104 to train the model to generate synthetic images 110.

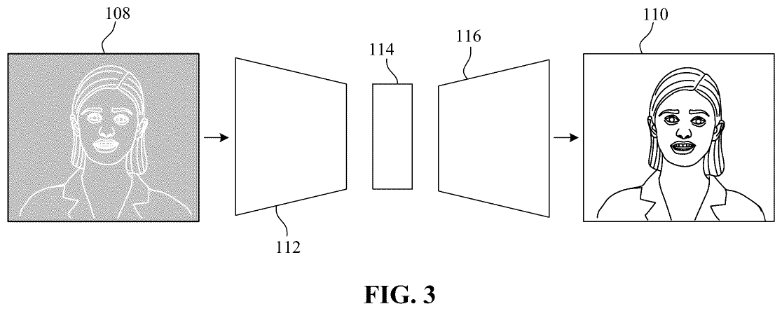

FIG. 3 illustrates machine learning model 104's generation of synthetic images 110 from silhouette images 108. Illustratively, machine learning model 104 is a neural network that includes encoder 112, coupled to one or more layers 114, which in turn, are coupled to a decoder 116. Machine learning model 104, in certain embodiments, is a Pix2Pix conditional generative adversarial network (GAN) trained to perform image-to-image translation. Based on the conditional GAN, machine learning model 104 generates a target image, conditional on a given input image. In general, a GAN includes two neural networks referred to as a generator and a discriminator that engage in a zero-sum game with one another. Given a training set, a GAN is capable of learning to generate new data with the same statistics as the training set. As an illustrative example, a GAN that is trained on an image or image library is capable of generating different images that appear authentic to a human observer. The GAN generator generates images. The GAN discriminator determines a measure of realism of the images generated by the generator. As both neural networks may be dynamically updated during operation (e.g., continually trained during operation), the GAN is capable of learning in an unsupervised manner where the generator seeks to generate images with increasing measures of realism as determined by the discriminator. With the Pix2Pix GAN, specifically, the GAN changes the loss function such that the generated image is plausible in the context of the target domain and is a plausible translation of an image input to the model. As a Pix2Pix GAN, machine learning model 104 can perform an image-to-image transformation of a merged silhouette image to generate a synthetic image.

Synthetic images 110 generated by machine learning model 104 are unimodal but are used for training a multimodal machine learning model (e.g., multimodal rendering network) to generate voice-animated digital humans. Trained using synthetic images 110, the multimodal machine learning model generates voice-animated digital humans whose head movements and mouth movements, including the lips, are accurately aligned. Each of synthetic images 110 can depict the human face with a different mouth shape.

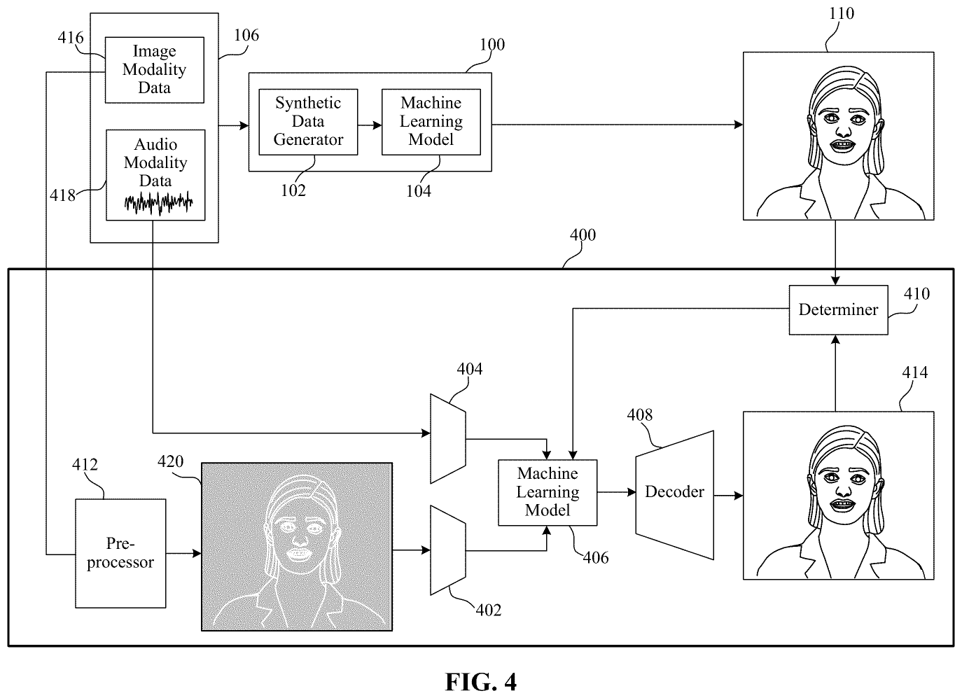

FIG. 4 illustrates the use of synthetic images 110 generated by architecture 100 for training a multimodal rendering network 400. Note that the operations performed by architecture 100 can occur concurrently with or preceding the training of multimodal rendering network 400. Multimodal rendering network 400 illustratively includes silhouette encoder 402, audio encoder 404, machine learning model 406, decoder 408, determiner 410, and preprocessor 412. Multimodal rendering network 400 processes training data 106 in learning to generate voice-animated digital human 414. Training data 106 includes image modality data 416 and audio modality data 418. Image modality data 416 used for training of machine learning model 406 includes an image, a corresponding silhouette (e.g., keypoints, contours) of the image, and pose data. The silhouette can efficiently be represented by 2D coordinates. Audio modality data 418 comprises vectorial representations (corresponding to audio waves) that numerically encode human speech. Preprocessor 412 generates partial drawings 420 based on image modality data 416. Partial drawings 420 can be generated using a filter or processor to filter out the mouth and jaw region thereby creating from the silhouette a partial of the silhouette, which comprises only the upper head portion. Multiple images of voice-animated digital humans are similarly generated along with voice-animated digital human 414 and are rendered in sequence to produce animation of the digital human. The sequential rendering of the multiple images is performed in coordination with the audio rendering of human speech. Thus, the voice-animated digital human appears to speak as, and with the voice of, a human.

Note the mouth portion of partial drawings 420 is omitted. The mouth portion of voice-animated digital human 414 is generated based on visemes corresponding to audio modality data 418. A viseme specifies a shape of a mouth at the apex of a given phoneme. Each phoneme is associated with, or is generated by, one viseme. Each viseme may represent one or more phonemes. In this regard, there is a many to one mapping of phonemes to visemes. Visemes are typically generated as artistic renderings of the shape of a mouth, e.g., lips, in speaking a particular phoneme. Audio encoder 404 pushes each viseme corresponding to the audio modality into a latent space shared with image modality data 416. Partial drawings 420 are input to silhouette encoder 402, which compresses the corresponding data. The data is processed through multiple layers of machine learning model 406 and decoded by decoder 408 to generate voice-animated digital human 414.

Synthetic images 110 provide a ground truth for training multimodal rendering network 400 through successive learning epochs. Multimodal rendering network 400 undergoes iterative changes to reduce the difference between images 414 generated by the network and synthetic images 110 generated by architecture 100. The differences are determined by determiner 410. In various embodiments, determiner 410 computes a quantitative measure of the differences based on an L1 loss, GAN loss, VGG loss, or other perceptual loss metric. Because synthetic images 110 are trained with synthetic data that disentangles the image and audio modalities, multimodal rendering network 400 is able to learn to generate voice-animated digital humans in which the mouth and lip movements of the digital humans are realistically aligned with the audio (speech) of the digital humans. More realistic alignment is achieved because in training multimodal rendering network 400 the image data does not dominate over the audio, which otherwise leads to overfitting and poor alignment of image and audio.

Architecture 100 generates synthetic images 110 from synthetic data. But the synthetic data is derived from the same data that is input to multimodal rendering network 400. The synthetic data, however, is essentially image data disentangled from the other modalities of the training data input to multimodal rendering network 400. Thus, synthetic images 110 generated from the synthetic data can provide a ground truth in which the correlation between head motion (image modality data 416) and mouth motion (audio modality data 418) is eliminated. In one aspect, the mouth motion is determined by the visemes that, as described above, audio encoder 404 pushes into a latent space shared with image modality data 416. The process operates to synchronize the mouth motion and speech rendering of the voice-animated digital human so that, as rendered, the voice-animated digital human appears to have the natural speaking capability of a human.

Synthetic images 110 are the ground truth for training machine learning model 406. Image modality data 416, which is also input to synthetic data generator 102 to generate synthetic data for deriving synthetic images 110, is the same as that used, along with audio modality data 418, to generate partial drawings 420, albeit with the mouth eliminated. The mouth keypoints excluded from partial drawings 420 nonetheless are correlated with the audio modality data 418. The keypoints excluded from partial drawing 420 are ones used in deriving synthetic images 110 (the ground truth) and match the audio used by multimodal rendering network 400 to generate voice-animated digital human 414. Specifically, the keypoints for the mouth position of the lower head portion silhouette used to generate synthetic images 110 can be indexed, tagged, or otherwise matched to audio and visemes input to machine learning model 406. It follows, therefore, that the audio and mouth portion of voice-animated digital human 414 that machine learning model 406 is trained to generate are correlated. Since audio modality data 418 corresponds to the keypoints used to derive the mouth position of the lower head portion of synthetic images 110, the mouth portion of synthetic images 110 corresponds to the mouth portion of voice-animated digital human 414. Since the correlation between the mouth and head portions of voice-animated digital human 414 has been undone, however, there is no correlation between head motion and mouth motion of voice-animated digital human 414.

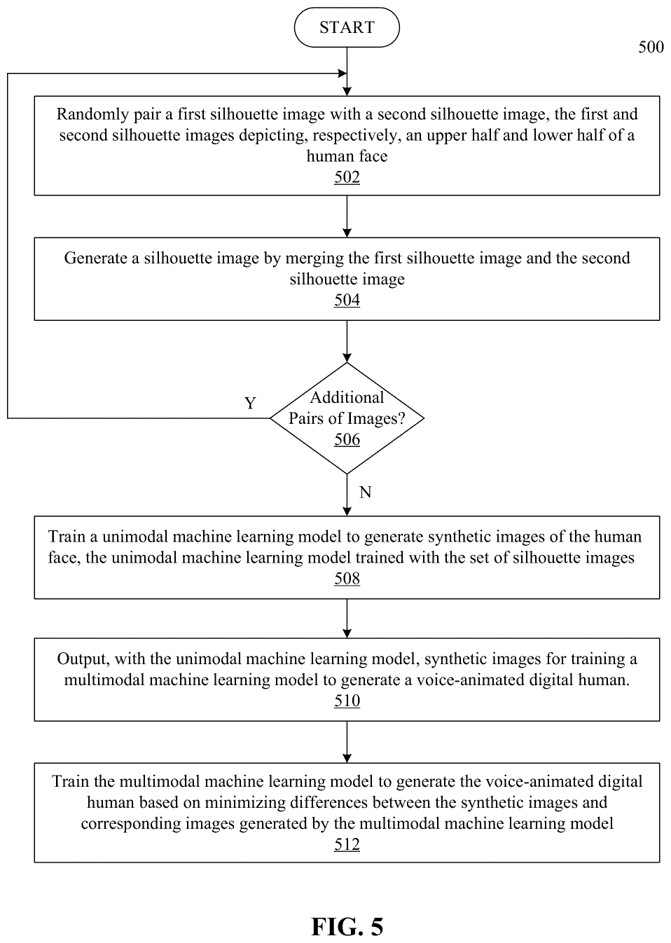

FIG. 5 illustrates an example method 500 that may be performed by a system executing architecture 100. As described, architecture 100 may be executed by a data processing system (e.g., computer) as described in connection with FIG. 7.

In block 502, the system randomly pairs a first silhouette image with a second silhouette image. The first silhouette image and the second silhouette image depict, respectively, an upper half and lower half of a human face. The silhouette images can be extracted from or generated based on training data 106 that is also input to a multimodal rendering network for generating voice-animated digital humans.

In block 504, the system generates a silhouette image. The silhouette image is generated from merging the first silhouette image and the second silhouette image. The system at block 506 continues to pair silhouette images until all images that are part of training data 106 have been paired. The silhouette images generated, taken collectively, represent a set of silhouette images 108.

In block 508, the system uses the set of silhouette images 108 to train unimodal machine learning model 104. Once trained, machine learning 104 is capable of generating synthetic images 110. Any correlation between the original images of training data 106 has been undone by the process of merging to generate silhouette images 108. Head and mouth (including lips) motions in synthetic images 110, accordingly, are uncorrelated.

In block 510, the system outputs synthetic images 110. Synthetic images 110 are input to a multimodal rendering network.

In block 512, the multimodal rendering network is trained using synthetic images 110. The multimodal rendering network is trained to generate voice-animated digital humans. The multimodal rendering network can be trained through successive epochs to reduce the difference between the voice-animated digital humans generated by the network and synthetic images 110. Each network-generated image of a digital human can uniquely correspond to one of synthetic images 110. By iteratively training the multimodal rendering network to minimized differences with synthetic images 110, the multimodal rendering network learns to generate voice-animated digital humans whose head movements and mouth movements are realistically aligned.

Although described herein primarily in the context of image and audio disentanglement, architecture 100 performs other tasks in which modality entanglement is an issue or where a rendering system benefits from generalization. For example, architecture 100 can be used to generalize a multimodal rendering network for multiple identity renderings. Passing identity images along with a silhouette images, architecture 100 can use the modality of multiple identities to train the multimodal rendering network so that the network learns to render multiple, arbitrary identities.

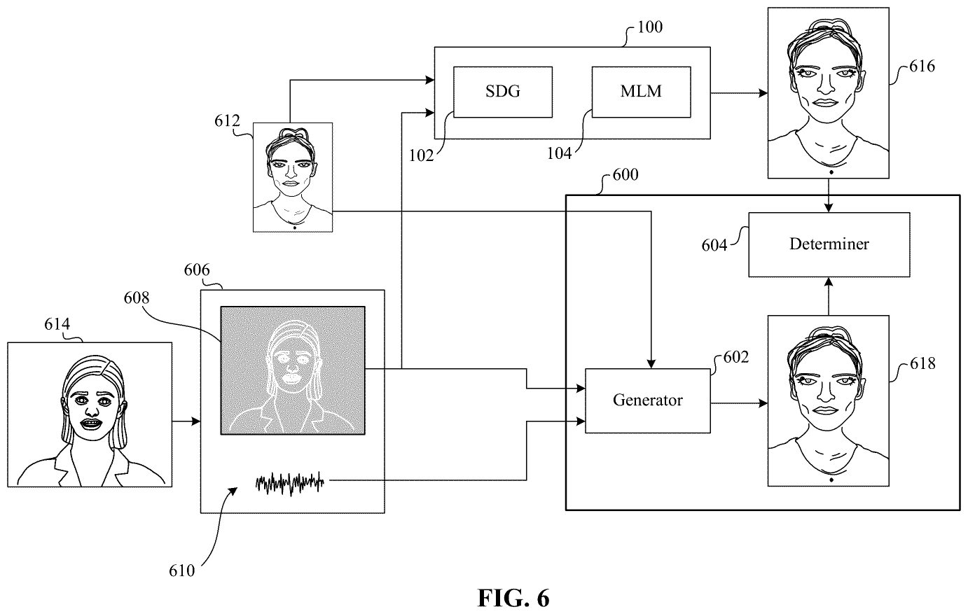

In FIG. 6, multimodal rendering network 600 is trained, using the output of architecture 100, to render an entity whose physical appearance has one identity but the voice and speaking style of a different identity. Multimodal rendering network 600 illustratively includes generator 602 and determiner 604. Input 606 to multimodal rendering network 600 includes silhouette 608 and audio 610 for a first identity corresponding to voice-animated digital human 614. Additionally, an image template 612 corresponding to a second identity is input to generator 602 of multimodal rendering network 600. Architecture 100 disentangles the modalities of input 606 to generate synthetic image 616 corresponding to the second identity. Multimodal rendering network 600 uses silhouette 608 and audio 610 corresponding to the first identity to generate the speaking style and mouth movements for the second identity. Image template 612 provides the texture of the second identity, such as facial features, hair color, clothing fabric, etc.

Thus, using the image template 612, multimodal rendering network 600 generates voice-animated digital human 618 corresponding to the second identity. Multiple images of voice-animated digital humans are similarly generated along with voice-animated digital human 618 and are sequentially rendered in coordination with human speech audio to produce animation of the digital human. Voice-animated digital human 618 has the facial features, hair color, and other textural aspects of the second identity. The speech of voice-animated digital human 618, however, has the mouth movements and voice of the first identity. With different image templates, multimodal rendering network 600 is able to learn how to generate multiple identity renderings by minimizing the difference between the voice-animated images the network generates and the synthetic images generated by architecture 100.

In other embodiments, architecture 100 performs knowledge distillation. Knowledge distillation enables a multimodal rendering network to be implemented as a smaller network. As a smaller network, multimodal rendering network learns only the relevant features from separate modalities to generate voice-animated digital humans. The multimodal rendering network is able to unlearn any features that are not significant and prevents overfitting while also keeping the network smaller for performing inferences faster.

FIG. 7 illustrates an example implementation of a data processing system 700. As defined herein, the term “data processing system” means one or more hardware systems configured to process data, each hardware system including at least one processor and memory, wherein the processor is programmed with computer-readable instructions that, upon execution, initiate operations. Data processing system 700 can include a processor 702, a memory 704, and a bus 706 that couples various system components including memory 704 to processor 702.

Processor 702 may be implemented as one or more processors. In an example, processor 702 is implemented as a central processing unit (CPU). Processor 702 may be implemented as one or more circuits capable of carrying out instructions contained in program code. The circuit may be an integrated circuit or embedded in an integrated circuit. Processor 702 may be implemented using a complex instruction set computer architecture (CISC), a reduced instruction set computer architecture (RISC), a vector processing architecture, or other known architectures. Example processors include, but are not limited to, processors having an 10×6 type of architecture (IA-32, IA-64, etc.), Power Architecture, ARM processors, and the like.

Bus 706 represents one or more of any of a variety of communication bus structures. By way of example, and not limitation, bus 706 may be implemented as a Peripheral Component Interconnect Express (PCIe) bus. Data processing system 700 typically includes a variety of computer system readable media. Such media may include computer-readable volatile and non-volatile media and computer-readable removable and non-removable media.

Memory 704 can include computer-readable media in the form of volatile memory, such as random-access memory (RAM) 708 and/or cache memory 710. Data processing system 700 also can include other removable/non-removable, volatile/non-volatile computer storage media. By way of example, storage system 712 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 706 by one or more data media interfaces. Memory 704 is an example of at least one computer program product.

Memory 704 is capable of storing computer-readable program instructions that are executable by processor 702. For example, the computer-readable program instructions can include an operating system, one or more application programs, other program code, and program data. The computer-readable program instructions may implement any of the different examples of architecture 100 as described herein, including synthetic data generator 102 and machine learning model 104. Processor 702, in executing the computer-readable program instructions, is capable of performing the various operations described herein that are attributable to a computer, including the operations of method 500 described in connection with FIG. 5. It should be appreciated that data items used, generated, and/or operated upon by data processing system 700 are functional data structures that impart functionality when employed by data processing system 700. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor. Examples of data structures include images and meshes.

Data processing system 700 may include one or more Input/Output (I/O) interfaces 718 communicatively linked to bus 706. I/O interface(s) 718 allow data processing system 700 to communicate with one or more external devices and/or communicate over one or more networks such as a local area network (LAN), a wide area network (WAN), and/or a public network (e.g., the Internet). Examples of I/O interfaces 718 may include, but are not limited to, network cards, modems, network adapters, hardware controllers, etc. Examples of external devices also may include devices that allow a user to interact with data processing system 700 (e.g., a display, a keyboard, a microphone for receiving or capturing audio data, speakers, and/or a pointing device).

Data processing system 700 is only one example implementation. Data processing system 700 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 7 is not intended to suggest any limitation as to the scope of use or functionality of example implementations described herein. Data processing system 700 is an example of computer hardware that is capable of performing the various operations described within this disclosure. In this regard, data processing system 700 may include fewer components than shown or additional components not illustrated in FIG. 7 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document now will be presented.

As defined herein, the singular forms “a,” “an,” and “the” are intended to include the plural forms as well, unless the context clearly indicates otherwise.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. The different types of memory, as described herein, are examples of a computer readable storage media. A non-exhaustive list of more specific examples of a computer readable storage medium may include: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “one or more embodiments,” or similar language mean that a particular feature, structure, or characteristic described in connection with the embodiment is included in at least one embodiment described within this disclosure. Thus, appearances of the phrases “in one embodiment,” “in an embodiment,” “in one or more embodiments,” and similar language throughout this disclosure may, but do not necessarily, all refer to the same embodiment. The terms “embodiment” and “arrangement” are used interchangeably within this disclosure.

As defined herein, the term “processor” means at least one hardware circuit. The hardware circuit may be configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” and similar language as described above, e.g., “if,” “when,” or “upon,” mean responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

A computer program product may include a computer readable storage medium (or media) having computer readable program instructions thereon for causing a processor to carry out aspects of the present invention. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Computer readable program instructions may specify state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In this way, operatively coupling the processor to program code instructions transforms the machine of the processor into a special-purpose machine for carrying out the instructions of the program code. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowcharts or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

The description of the embodiments provided herein is for purposes of illustration and is not intended to be exhaustive or limited to the form and examples disclosed. The terminology used herein was chosen to explain the principles of the inventive arrangements, the practical application or technical improvement over technologies found in the marketplace, and/or to enable others of ordinary skill in the art to understand the embodiments disclosed herein. Modifications and variations may be apparent to those of ordinary skill in the art without departing from the scope and spirit of the described inventive arrangements. Accordingly, reference should be made to the following claims, rather than to the foregoing disclosure, as indicating the scope of such features and implementations.

What is claimed is:

1. A computer-implemented method, comprising:
generating a set of silhouette images corresponding a human face, wherein the generating undoes a correlation between an upper portion and a lower portion of the human face depicted by each silhouette image;
training a unimodal machine learning model to generate synthetic images of the human face, wherein the unimodal model is trained with the set of silhouette images; and
outputting, by the unimodal machine learning model, synthetic images for training a multimodal rendering network to generate a voice-animated digital human.

2. The method of claim 1, wherein the method further comprises:
training the multimodal rendering network based on minimizing differences between the synthetic images and images generated by the multimodal rendering network.

3. The method of claim 1, wherein the generating a silhouette image comprises:
randomly pairing a first silhouette image with a second silhouette image, wherein the first silhouette image and the second silhouette image depict an upper half and lower half, respectively, of the human face; and
generating a silhouette image by merging the first silhouette image and the second silhouette image.

4. The method of claim 3, wherein the merging the first silhouette image and the second silhouette image comprises:
extracting associated sets of keypoints from each of the first silhouette image and the second silhouette image;
frontalizing the sets of keypoints of each of the first silhouette image and the second silhouette image;
generating a frontalized silhouette by adding frontalized sets of keypoints of first and second silhouette images; and
de-frontalizing the frontalized silhouette, thereby generating the silhouette image.

5. The method of claim 4, wherein the frontalizing the sets of keypoints comprises:
multiplying the sets of keypoints of the first silhouette image and the second silhouette image by an inverse of a head pose matrix of the first image and an inverse of a head pose matrix of the second silhouette image, respectively.

6. The method of claim 4, wherein the de-frontalizing the frontalized silhouette comprises:
multiplying the frontalized silhouette by either the head pose matrix of the first image, or the head pose matrix of the second image.

7. The method of claim 1, wherein the generating each synthetic image comprises:
performing an image-to-image transformation of a corresponding merged silhouette image.

8. A system, comprising:
one or more processors configured to initiate operations including:
generating a set of silhouette images corresponding a human face, wherein the generating undoes a correlation between an upper portion and a lower portion of the human face depicted by each silhouette image;
training a unimodal machine learning model to generate synthetic images of the human face, wherein the unimodal model is trained with the set of silhouette images; and
outputting, by the unimodal machine learning model, synthetic images for training a multimodal rendering network to generate a voice-animated digital human, wherein the training the multimodal rendering network is based on minimizing differences between the synthetic images and images generated by the multimodal rendering network.

9. The system of claim 8, wherein the one or more processors are configured to initiate operations further including:
training the multimodal rendering network based on minimizing differences between the synthetic images and images generated by the multimodal rendering network.

10. The system of claim 8, wherein the generating a silhouette image comprises:
randomly pairing a first silhouette image with a second silhouette image, wherein the first silhouette image and the second silhouette image depict an upper half and lower half, respectively, of the human face; and
generating a silhouette image by merging the first silhouette image and the second silhouette image.

11. The system of claim 10, wherein the merging the first silhouette image and the second silhouette image comprises:
extracting associated sets of keypoints from each of the first silhouette image and the second silhouette image;
frontalizing the sets of keypoints of each of the first silhouette image and the second silhouette image;
generating a frontalized silhouette by adding frontalized sets of keypoints of first and second silhouette images; and
de-frontalizing the frontalized silhouette, thereby generating the silhouette image.

12. The system of claim 11, wherein the frontalizing the sets of keypoints comprises:
multiplying the sets of keypoints of the first silhouette image and the second silhouette image by an inverse of a head pose matrix of the first image and an inverse of a head pose matrix of the second silhouette image, respectively.

13. The system of claim 11, wherein the de-frontalizing the frontalized silhouette comprises:
multiplying the frontalized silhouette by either the head pose matrix of the first image, or the head pose matrix of the second image.

14. The system of claim 8, wherein the generating each synthetic image comprises:
performing an image-to-image transformation of a corresponding merged silhouette image.

15. A computer program product, comprising:
one or more computer readable storage media, and program instructions collectively stored on the one or more computer readable storage media, wherein the program instructions are executable by one or more processors to initiate operations including:
generating a set of silhouette images corresponding a human face, wherein the generating undoes a correlation between an upper portion and a lower portion of the human face depicted by each silhouette image;
training a unimodal machine learning model to generate synthetic images of the human face, wherein the unimodal model is trained with the set of silhouette images; and
outputting, by the unimodal machine learning model, synthetic images for training a multimodal rendering network to generate a voice-animated digital human, wherein the training the multimodal rendering network is based on minimizing differences between the synthetic images and images generated by the multimodal rendering network.

16. The computer program product of claim 15, wherein the program instructions are executable by the processor to cause the processor to initiate operations further including:
training the multimodal rendering network based on minimizing differences between the synthetic images and images generated by the multimodal rendering network.

17. The computer program product of claim 15, wherein the generating a silhouette image comprises:
randomly pairing a first silhouette image with a second silhouette image, wherein the first silhouette image and the second silhouette image depict an upper half and lower half, respectively, of the human face; and
generating a silhouette image by merging the first silhouette image and the second silhouette image.

18. The computer program product of claim 17, wherein the merging the first silhouette image and the second silhouette image comprises:
extracting associated sets of keypoints from each of the first silhouette image and the second silhouette image;
frontalizing the sets of keypoints of each of the first silhouette image and the second silhouette image;
generating a frontalized silhouette by adding frontalized sets of keypoints of first and second silhouette images; and
de-frontalizing the frontalized silhouette, thereby generating the silhouette image.

19. The computer program product of claim 18, wherein the frontalizing the sets of keypoints comprises:
multiplying the sets of keypoints of the first silhouette image and the second silhouette image by an inverse of a head pose matrix of the first image and an inverse of a head pose matrix of the second silhouette image, respectively.

20. The computer program product of claim 18, wherein the de-frontalizing the frontalized silhouette comprises:
multiplying the frontalized silhouette by either the head pose matrix of the first image, or the head pose matrix of the second image.
